(19) United States
(12) Patent Application Publication
(10) Pub. No.: US 2007/0220472 A1
(43) Pub. Date: Sep. 20, 2007

(54) Computer aided wave-shaped circuit line drawing method and system

(75) Inventors: David Wei, Taipei (TW); Bg Fan, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/365,645

(22) Filed: Feb. 28, 2006

(51) Int. Cl. G06F 17/50

(52) U.S. Cl. 716/11

(57) ABSTRACT

A computer aided wave-shaped circuit line drawing method and system is proposed, which is designed for use with a computer platform for providing a user-operated wave-shaped circuit line drawing function, and which is characterized by the utilization of computer-aided graphic drawing technology to allow a user to define a set of dimensional attributes for a wave-shaped microstrip line, and whereby the shape of the wave-shaped microstrip line will be automatically drawn on a circuit layout diagram. Compared to the prior art, since the invention allows the dimensional attributes and locations of each constituent portions (i.e., segments and turning points) in the wave-shaped microstrip to be precisely drawn on the circuit layout diagram, it allows the realization of a microwave digital circuit board from the circuit layout diagram to have precise characteristic impedance and thus precise electrical performance in actual operation.

### BACKGROUND OF THE INVENTION

1. Field of the Invention

This invention relates to computer-aided design (CAD) technology, and more particularly, to a computer aided wave-shaped circuit line drawing method and system which is designed for use in conjunction with a computer platform for providing a user-operated wave-shaped circuit line drawing function that allows the user (i.e., a circuit layout engineer) to draw a circuit layout diagram more precisely for a wave-shaped circuit line, such as a differential pair of microstrips with alternating U-shaped portions used on microwave digital circuit board.

2. Description of Related Art

With the advent of wireless digital communication technologies, such as wireless networking, mobile phones, GPS (Global Positioning System), etc., the design and manufacture of microwave digital circuit board that processes digital signals in the gigahertz range is a highly demanded technology in the electronics industry. In circuit design, microwave digital circuit boards are typically provided with microstrips, which are electrically-conductive lines, for conducting extremely high frequency signals, typically in the range from 1 GHz to 3 GHz (gigahertz).

Since a microwave digital circuit board is used to conduct extremely high frequency digital signals, the characteristic impedance thereof is an important factor related to the electrical characteristics of the conducting circuitry on the circuit board. If the characteristic impedance of a microwave digital circuit board is deviated from its intended value, it will adversely affect the electrical performance of signal reception, transmission, and demodulation. For this reason, in the manufacture of microwave digital circuit boards, it is strictly required that each microstrip line on a microwave digital circuit board be designed with precise dimensions (line length, line width, gap width, etc.) and positions such that the resultant characteristic impedance would be precise.

In the design and manufacture of microwave digital circuit boards, a differential microstrip pair 30 as illustrated in FIG. 1 is often used for conducting the microwave digital signals. As shown, this differential microstrip pair 30 includes a lined microstrip 31 and a wave-shaped microstrip 32, wherein the wave-shaped microstrip 32 is formed with a series of U-shaped portions 40 (such as 3 U-shaped portions 40 in FIG. 1), and as shown in FIG. 2 each U-shaped portion 40 is further formed with a number of turning points P1, P2, P3, P4, P5, P6, P7, P8 and a number of line segments 41, 42, 43, 44, 45, 46, 47, with each pair of adjacent U-shaped portions 40 being connected by a line segment 48.

As illustrated in FIG. 2, in circuit layout, the lined microstrip 31 and the wave-shaped microstrip 32 are both equal in width (denoted by W); the line segments 41, 42, 43, 44, 45, 46, 47 in each U-shaped portion 40 are symmetrically shaped, respectively having widths denoted by W1, W2, W3, W4, W3, W2, W1 and lengths denoted by a, b, c, d, c, b, a; and the angles between each adjacent pair of line segments 41,42, 43, 44, 45, 46,47 are each 135 □(i.e., each U-shaped portion 40 is symmetrically shaped). Further, each lined microstrip 31 includes a widened portion 50 having a width W5 and a length g in opposite to each U-shaped portion 40.

One drawback to the present CAD circuit layout drawing systems, however, is that it would not allow circuit layout engineers to draw the above-mentioned differential microstrip pair 30 precisely in size and location. For instance, as illustrated in FIG. 1, the resulted differential microstrip pair 30 manually drawn by using present CAD circuit layout drawing systems would commonly have the following dimensional errors: L1≠L2≠L3 [symbol] v1≠v2≠v3 [symbol] u1≠u2≠u3 [symbol] S1≠A S2≠S3 [symbol] f1≠f2≠f3, and e1≠e2, which results in an unsymmetrical shape of each U-shaped portion 40 in the wave-shaped microstrip 32 and thus would cause a deviation in the resultant characteristic impedance. The cause of these dimensional errors is due to that these objects are manually drawn by the circuit layout engineers with the mouse, and therefore their sizes and positions would be imprecise. When the imprecisely drawn differential microstrip pair 30 is realized into actual circuitry, the characteristic impedance thereof would be deviated from the intended value and cause the entire microwave digital circuit board unable to process the high-frequency gigahertz digital signals in the intended manner.

### SUMMARY OF THE INVENTION

It is therefore an objective of this invention to provide a computer aided wave-shaped circuit line drawing method and system which allows circuit layout engineers to draw a differential microstrip pair on the circuit layout diagram of a microwave digital circuit board with absolute accuracy in size and position.

The computer aided wave-shaped circuit line drawing method and system according to the invention is designed for use in conjunction with a computer platform for providing a user-operated wave-shaped circuit line drawing function that allows the user (i.e., a circuit layout engineer) to draw a circuit layout diagram more precisely for a wave-shaped circuit line, such as a differential pair of microstrips with alternating U-shaped portions used on microwave digital circuit board.

The computer aided wave-shaped circuit line drawing method according to the invention comprises: (1) responding to a user-operated range defining event by defining a starting point and an ending point and a set of related dimensional attributes for the wave-shaped circuit line to be drawn on the circuit layout diagram; (2) responding to a user-operated dimension defining event by defining a set of dimensional attributes for each constituent portions of the wave-shaped circuit line within the range defined by the range defining module; (3) computing for a set of coordinate values for the location of each turning point in the U-shaped portion of the wave-shaped circuit line on the circuit layout diagram based on the user-defined and automatically-computed dimensional attributes; and (4) performing a delineating procedure based on the user-defined and automatically computed dimensional attributes and coordinate values to delineate the shape of the wave-shaped circuit line on the circuit layout diagram.

In architecture, the computer aided wave-shaped circuit line drawing system according to the invention comprises: (A) a range defining module, which is used to provide a user-operated range defining function for defining a starting point and an ending point and a set of related dimensional attributes for the wave-shaped circuit line to be drawn on the circuit layout diagram; (B) a dimension defining module, which is used to provide a user-operated dimension defining function for defining a set of dimensional attributes for each constituent portions of the wave-shaped circuit line within the range defined by the range defining module; (C) a coordinate computation module, which is capable of computing for a set of coordinate values for the location of each turning point in the U-shaped portion of the wave-shaped circuit line on the circuit layout diagram; and (D) a delineating module, which is capable of performing a delineating procedure based on the dimensional attributes defined and computed by the dimension defining module and the coordinate values obtained by the coordinate computation module to delineate the shape of the wave-shaped circuit line on the circuit layout diagram within the range defined by the range defining module.

The computer aided wave-shaped circuit line drawing method and system according to the invention is characterized by the utilization of computer-aided graphic drawing technology to allow a user to define a set of dimensional attributes for a wave-shaped microstrip line, and whereby the shape of the wave-shaped microstrip line will be automatically drawn on a circuit layout diagram. Compared to the prior art, since the invention allows the dimensional attributes and locations of each constituent portions (i.e., segments and turning points) in the wave-shaped microstrip to be precisely drawn on the circuit layout diagram, it allows the realization of a microwave digital circuit board from the circuit layout diagram to have precise characteristic impedance and thus precise electrical performance in actual operation.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic circuit layout diagram showing a pair of differential microstrips that are manually drawn by using a traditional CAD program;

FIG. 2 is a schematic circuit layout diagram used to depict the shape of each U-shaped portion of the differential microstrip pair shown in FIG. 1;

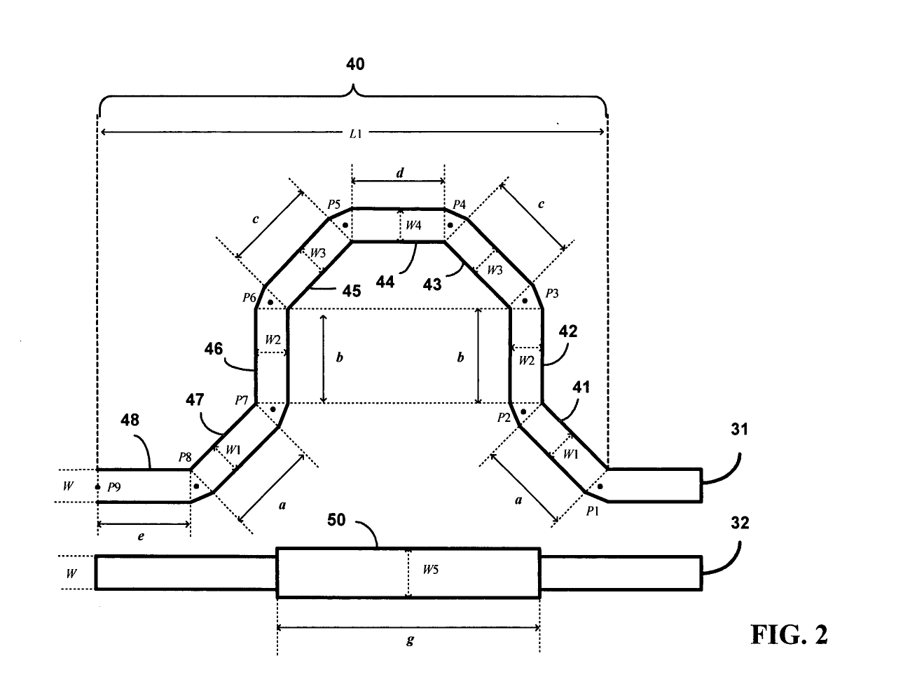

FIG. 3 is a schematic diagram showing the application and object-oriented component model of the computer aided wave-shaped circuit line drawing system according to the invention;

FIGS. 4A-4B are schematic circuit layout diagrams used to depict the process of drawing a differential microstrip pair by using the computer aided wave-shaped circuit line drawing system of the invention;

FIGS. 5A-5B are schematic circuit layout diagrams used to depict the process of drawing a bending differential microstrip pair by using the computer aided wave-shaped circuit line drawing system of the invention; and

FIGS. 6A-6B are schematic circuit layout diagrams used to depict the process of a rounded jointing method utilized by the computer aided wave-shaped circuit line drawing system of the invention for joining two wave-shaped microstrips having different widths and extending directions.

### DETAILED DESCRIPTION OF PREFERRED EMBODIMENTS

The computer aided wave-shaped circuit line drawing method and system according to the invention is disclosed in full details by way of preferred embodiments in the following with reference to the accompanying drawings.

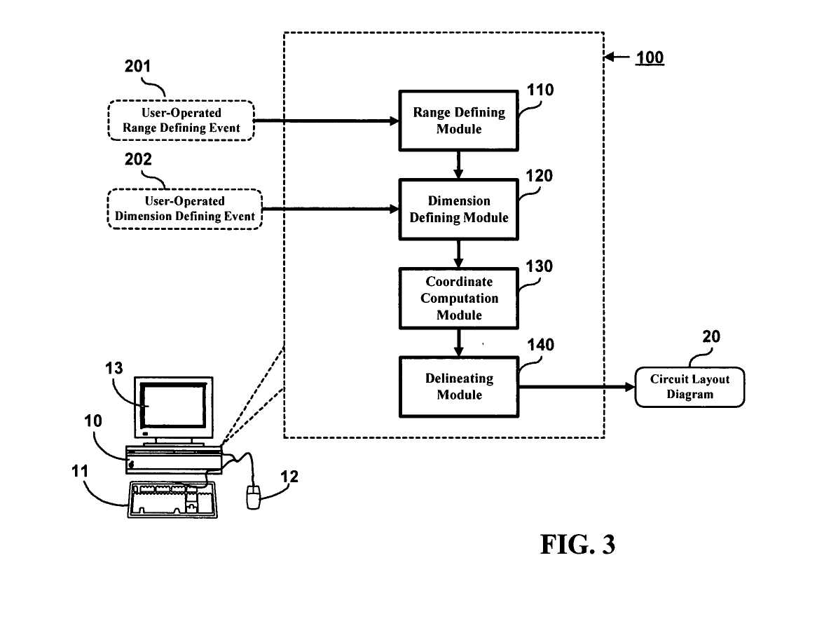

FIG. 3 is a schematic diagram showing the application and object-oriented component model of the computer aided wave-shaped circuit line drawing system according to the invention (as the part enclosed in the dotted box indicated by the reference numeral 100). As shown, the computer aided wave-shaped circuit line drawing system of the invention 100 is designed for use with a computer platform 10 for providing a user-operated wave-shaped circuit line drawing function that allows the user (i.e., a circuit layout engineer) to draw a circuit layout diagram 20, such as a differential pair of microstrips 30 with alternating U-shaped portions 40 used on microwave digital circuit boards.

As shown in FIG. 3, in architecture, the computer aided wave-shaped circuit line drawing system of the invention 100 is based on an object-oriented component model which comprises: (A) a range defining module 110; (B) a dimension defining module 120; (C) a coordinate computation module 130; and (D) a delineating module 140. In practical implementation, the computer aided wave-shaped circuit line drawing system of the invention 100 can be fully realized by software-based computer code and integrated as a plug-in module to any existing CAD circuit layout drawing programs.

Firstly, the respective attributes and behaviors of the constituent modules 110, 120, 130, 140 of the computer aided wave-shaped circuit line drawing system of the invention 100 are described in details in the following

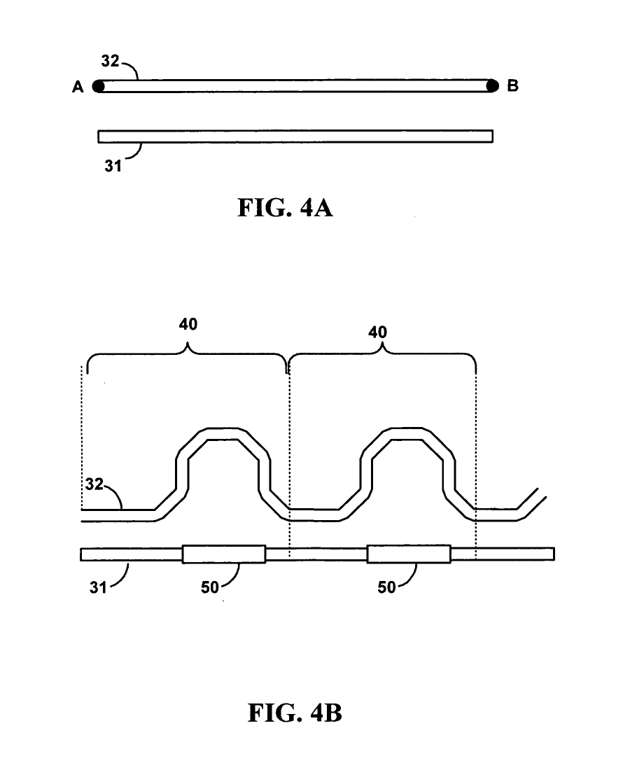

The range defining module 110 is designed to provide a user-operated range defining function for the user to define, as illustrated in FIG. 4A, a starting point A and an ending point B and related dimensional attributes, such as line width W and gap width S for the differential microstrip pair 30 to be drawn on the circuit layout diagram 20. It is assumed that the starting point A is located at the coordinates (x, y) and the ending point B is located at (s, t), then the range defining module 110 is capable of computing for the distance between the starting point A and the ending point B. In actual operation, the user can use the computer platform 10 to initiate a user-operated range defining event 201, for example by using the mouse 12 to pinpoint the location of the starting point A and the location of the ending point B on the circuit layout diagram 20 displayed on the monitor screen 13 of the computer platform 10, and by using a pop-up dialog box (not shown) to input the values of line width W and gap width S. This user-initiated action will cause the range defining module 110 to respond by first computing for the distance M between the starting point A and the ending point B, and then displaying a pair of straight line segments 31, 32, which are the primitive form of the differential microstrip pair 30 to be drawn on the circuit layout diagram 20, and where the first line segment 31 will be used to form a lined microstrip, while the second line segment 32 will be used to form a wave-shaped microstrip.

The dimension defining module 120 is designed to provide a user-operated dimension defining function for the use to define a set of dimensional attributes for each U-shaped portion 40 of the differential microstrip pair 30 defined by the range defining module 110. The user-defined dimensional attributes include the respective lengths (denoted by a, b, c, d, e) and respective widths (denoted by W1, W2, W3, W4, W5) of all the constituent segments 41, 42, 43, 44, 45, 46, 47 of the U-shaped portion 40. In actual operation, the user can use the computer platform 10 to initiate a user-operated dimension defining event 202, for example by using the keyboard 11 to input the values of (a, b, c, d, e) and (W1, W2, W3, W4, W5) through a dialog box (not shown). This user-initiated data-input action will cause the dimension defining module 120 to respond by first computing for the length L of each user-defined U-shaped portion 40 and the maximum number n of U-shaped portions 40 that can be accommodated within the distance M, based on the following two equations:
L=\sqrt{2}*a+\sqrt{2}*c+d+e
n=Integer (M/L)
Subsequently, the dimension defining module 120 will transfer the user-inputted values (a, b, c, d, e) and (W1, W2, W3, W4, W5) and the computed results (L, n) to the coordinate computation module 130 for further processing.

The coordinate computation module 130 is designed to perform a coordinate computation procedure to compute for a set of coordinate values for the respective locations of the turning points P1, P2, P3, P4, P5, P6, P7, P8 in the differential microstrip pair 30 on the circuit layout diagram 20 based on the values (W, S, M) defined and computed by the range defining module 110 and the user-defined values (a, b, c, d, e) and (W1, W2, W3, W4, W5) received by the dimension defining module 120. The computation is based on the following equations:
P1=(x, y) (the coordinates of the starting point A)
P2=(x+0.707*a, y+0.707*a)
P3=(x+0.707*a+b, y+0.707*a)
P4=(x+0.707*a+b+0.707*c, y+0.707*a+0.707*c)
P5=(x+0.707*a+b+0.707*c, y+0.707*a+0.707*c+d)
P6=(x+0.707*a+b, y+0.707*a+0.707*c+d+0.707*c)
P7=(x+0.707*a, y+0.707*a+0.707*c+d+0.707*c)
P8=(x, y+0.707*a+0.707*c+d+0.707*c+0.707*a)
P9=(x, y+0.707*a+0.707*c+d+0.707*c+0.707*a+e)
Subsequently, the coordinate computation module 130 will transfer the computed coordinate values of the turning points P1, P2, P3, P4, P5, P6, P7, P8 to the delineating module 140 for further processing.

The delineating module 140 is capable of performing a delineating procedure based on the dimensional attributes (W, S, M) defined and computed by the range defining module 110, the dimensional attributes (a, b, c, d, e) and (W1, W2, W3, W4, W5) defined by the dimension defining module 120, and the coordinate values of the turning points P1, P2, P3, P4, P5, P6, P7, P8 computed by the coordinate computation module 130 to delineate the layout of the differential microstrip pair 30 with a lined microstrip 31 and a wave-shaped microstrip 32, as illustrated in FIG. 4B, where the wave-shaped microstrip 32 includes a series of U-shaped portions 40, while the lined microstrip 31 includes a series of widened portions 50 respectively matched to the U-shaped portions 40 in the wave-shaped microstrip 32. The number of the U-shaped portions 40 is dependent on the distance M between the starting point A and the ending point B and the user-defined values (a, b, c, d, e), and is automatically determined to obtain the maximum number.

The following is a detailed description of a practical example of the application of the computer aided wave-shaped circuit line drawing system of the invention 100 during actual operation.

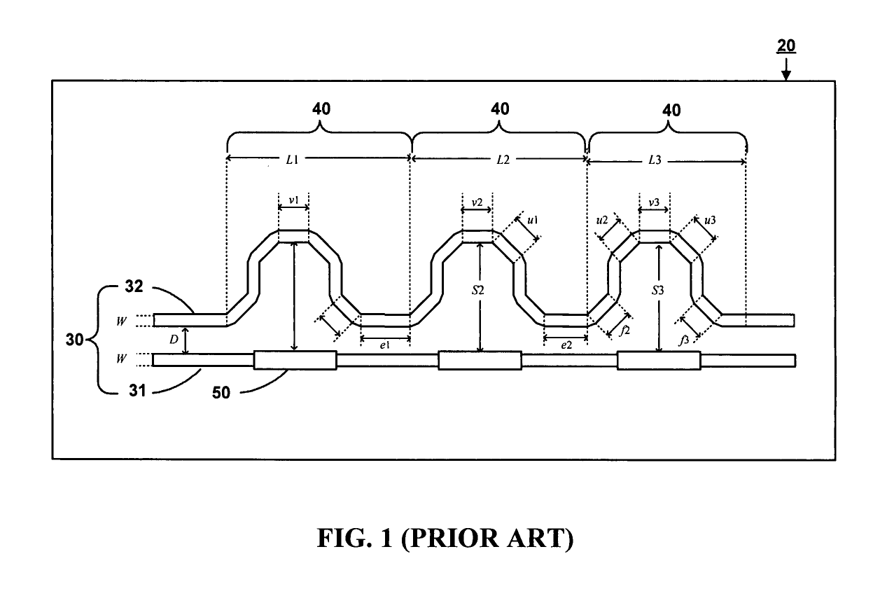

Referring first to FIG. 3, In actual operation, when the user (i.e., circuit layout engineer) wants to utilize the computer aided wave-shaped circuit line drawing system of the invention 100 to draw a differential microstrip pair 30 shown in FIG. 1, the user can first utilize the mouse 12 to click on a particular start button displayed on the monitor screen 13 to start the computer aided wave-shaped circuit line drawing system of the invention 100. When the computer aided wave-shaped circuit line drawing system of the invention 100 is started and displays a circuit layout diagram 20 on the monitor screen 13, the user can then utilize the mouse 12 to carry out a range defining task by first pinpointing a starting point A and an ending point B for the differential microstrip pair 30, as illustrated in FIG. 4A; and then using a pop-up dialog box (not shown) to input the values of line width W and gap width S for the differential microstrip pair 30. This user-initiated action will cause the range defining module 110 to respond by first computing for the distance M between the starting point A and the ending point B, and then displaying a pair of straight line segments 31, 32, which are the primitive form of the differential microstrip pair 30 to be drawn on the circuit layout diagram 20, and where the first line segment 31 will be used to form a lined microstrip, while the second line segment 32 will be used to form a wave-shaped microstrip. Next, the user can utilize another dialog box (not shown) provided by the dimension defining module 120 to define a set of dimensional attributes for each U-shaped portion 40 of the differential microstrip pair 30 defined by the range defining module 110, including the respective lengths (denoted by a, b, c, d, e) and respective widths (denoted by W1, W2, W3, W4, W5) of all the constituent segments 41, 42, 43, 44, 45, 46, 47 of the U-shaped portion 40. This user-initiated data-input action will cause the dimension defining module 120 to respond by first computing for the length L of each user-defined U-shaped portion 40 and the maximum number n of U-shaped portions 40 that can be accommodated within the distance M. Subsequently, the dimension defining module 120 will transfer the user-inputted values (a, b, c, d, e) and (W1, W2, W3, W4, W5) and other related data to the coordinate computation module. 130 for further processing. In response, the coordinate computation module 130 performs a coordinate computation procedure to compute for a set of coordinate values for the respective locations of the turning points P1, P2, P3, P4, P5, P6, P7, P8 in the differential microstrip pair 30 on the circuit layout diagram 20, and then transfers the computed coordinate values of the turning points P1, P2, P3, P4, P5, P6, P7, P8 to the delineating module 140 for further processing.

In response, the delineating module 140 performs a delineating procedure based on the range and size data (W, S, M) defined and computed by the range defining module 110, the dimensional attributes (a, b, c, d, e) and (W1, W2, W3, W4, W5) defined by the dimension defining module 120, and the coordinate values of the turning points P1, P2, P3, P4, P5, P6, P7, P8 computed by the coordinate computation module 130 to delineate the shape of the differential microstrip pair 30 with a lined microstrip 31 and a wave-shaped microstrip 32 as illustrated in FIG. 4B, where the wave-shaped microstrip 32 includes a series of U-shaped portions 40, while the lined microstrip 31 includes a series of widened portions 50 respectively in opposite to the U-shaped portions 40 in the wave-shaped microstrip 32.

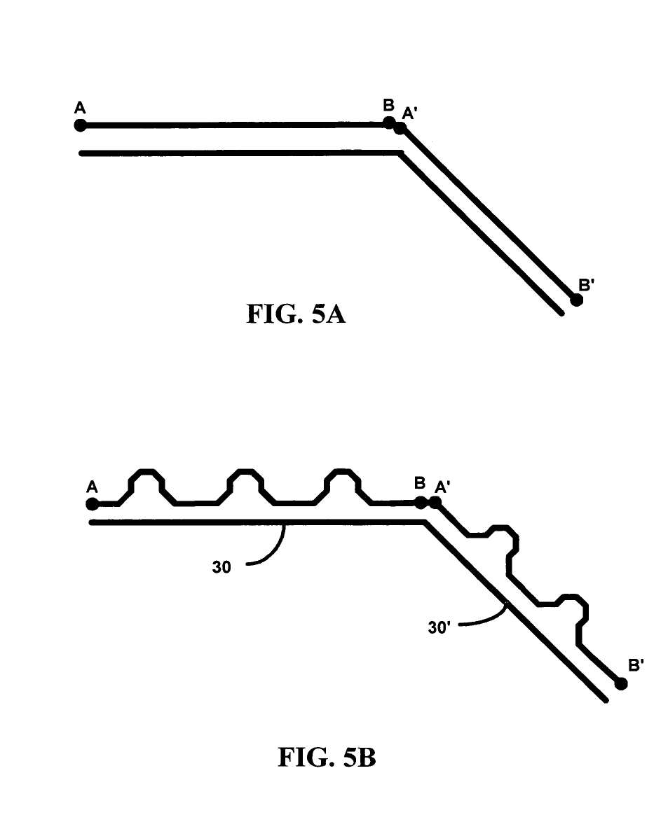

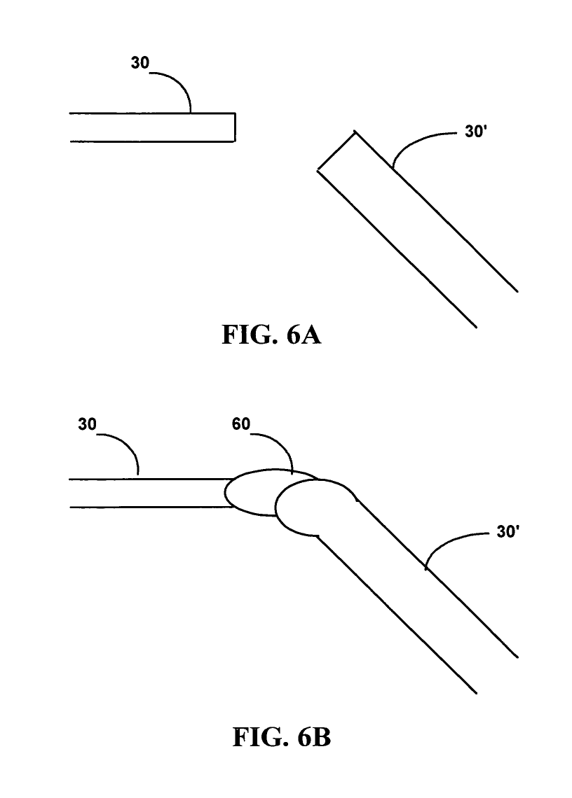

Subsequently, as shown in FIGS. 5A-5B, the computer aided wave-shaped circuit line drawing system of the invention 100 not only allows the user to draw a horizontal pair of microstrip lines (i.e., the above-mentioned differential microstrip pair 30), but also allows the user to join the differential microstrip pair 30 with a bending pair of differential microstrip lines 30′ at any desired angles. In actual operation, the user can first define a starting point A and an ending point B as illustrated in FIG. 5A for a straight section of differential microstrip pair 30, and then define a starting point A′ and an ending point B′ for a bending section of differential microstrip pair 30′, where the starting point A′ of the bending differential microstrip pair 30′ is substantially overlaid with the ending point B of the straight differential microstrip pair 30. This user-operated action will cause the computer aided wave-shaped circuit line drawing system of the invention 100 to draw the straight differential microstrip pair 30 and the bending differential microstrip pair 30′ as illustrated in FIG. 5B. Further, in the case that the straight differential microstrip pair 30 and the bending differential microstrip pair 30′ are different in widths as shown in FIG. 6A, then since the joint thereof is a turning point, the delineating module 140 will use a rounded joint 60 for joining the bending differential microstrip pair 30′ to the straight differential microstrip pair 30, which would allow the signal transmission to be smooth at the rounded joint 60.

In conclusion, the invention provides a computer aided wave-shaped circuit line drawing method and system which is designed for use with a computer platform for providing a user-operated wave-shaped circuit line drawing function, and which is characterized by the utilization of computer-aided graphic drawing technology to allow a user to define a set of dimensional attributes for a wave-shaped microstrip line, and whereby the shape of the wave-shaped microstrip line will be automatically drawn on a circuit layout diagram. Compared to the prior art, since the invention allows the dimensional attributes and locations of each constituent portions (i.e., segments and turning points) in the wave-shaped microstrip to be precisely drawn on the circuit layout diagram, it allows the realization of a microwave digital circuit board from the circuit layout diagram to have precise characteristic impedance and thus precise electrical performance in actual operation. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer aided wave-shaped circuit line drawing method for use on a computer platform for providing a user-operated wave-shaped circuit line drawing function for computer-aided drawing of a wave-shaped circuit line in a circuit layout diagram where the wave-shaped circuit includes at least one U-shaped portion;
the computer aided wave-shaped circuit line drawing method comprising:
responding to a user-operated range defining event by defining a starting point and an ending point and a set of related dimensional attributes for the wave-shaped circuit line to be drawn on the circuit layout diagram;
responding to a user-operated dimension defining event by defining a set of dimensional attributes for each constituent portions of the wave-shaped circuit line within the range defined by the range defining module;
computing for a set of coordinate values for the location of each turning point in the U-shaped portion of the wave-shaped circuit line on the circuit layout diagram based on the user-defined and automatically-computed dimensional attributes; and
performing a delineating procedure based on the user-defined and automatically-computed dimensional attributes and coordinate values to delineate the shape of the wave-shaped circuit line on the circuit layout diagram.

2. The computer aided wave-shaped circuit line drawing method of claim 1, wherein the circuit layout diagram is a microwave digital circuit board layout diagram.

3. The computer aided wave-shaped circuit line drawing method of claim 1, wherein the wave-shaped circuit line is a differential microstrip pair.

4. The computer aided wave-shaped circuit line drawing method of claim 1, wherein the delineating procedure further includes a bending differential microstrip pair drawing step to draw a bending differential microstrip pair at a user-defined angle with a straight differential microstrip pair.

5. The computer aided wave-shaped circuit line drawing method of claim 1, wherein the delineating procedure further includes a rounded jointing step which utilizes a rounded joint to join two wave-shaped circuit lines having different widths and extending directions.

6. A computer aided wave-shaped circuit line drawing system for use with a computer platform for providing a user-operated wave-shaped circuit line drawing function for computer-aided drawing of a wave-shaped circuit line in a circuit layout diagram where the wave-shaped circuit includes at least one U-shaped portion;
the computer aided wave-shaped circuit line drawing system comprising:
a range defining module, which is used to provide a user-operated range defining function for defining a starting point and an ending point and a set of related dimensional attributes for the wave-shaped circuit line to be drawn on the circuit layout diagram;
a dimension defining module, which is used to provide a user-operated dimension defining function for defining a set of dimensional attributes for each constituent portions of the wave-shaped circuit line within the range defined by the range defining module;
a coordinate computation module, which is capable of computing for a set of coordinate values for the location of each turning point in the U-shaped portion of the wave-shaped circuit line on the circuit layout diagram; and
a delineating module, which is capable of performing a delineating procedure based on the dimensional attributes defined and computed by the dimension defining module and the coordinate values obtained by the coordinate computation module to delineate the shape of the wave-shaped circuit line on the circuit layout diagram within the range defined by the range defining module.

7. The computer aided wave-shaped circuit line drawing system of claim 6, wherein the circuit layout diagram is a microwave digital circuit board layout diagram.

8. The computer aided wave-shaped circuit line drawing system of claim 6, wherein the wave-shaped circuit line is a differential microstrip pair.

9. The computer aided wave-shaped circuit line drawing system of claim 6, wherein the delineating module further includes a bending differential microstrip pair drawing function to draw a bending differential microstrip pair at a user-defined angle with a straight differential microstrip pair.

10. The computer aided wave-shaped circuit line drawing system of claim 6, wherein the delineating module further includes a rounded jointing function which utilizes a rounded joint to join two wave-shaped circuit lines having different widths and extending directions.
